(19) United States
(12) Patent Application Publication
(10) Pub. No.: US 2020/0117515 A1
(43) Pub. Date: Apr. 16, 2020

(54) METHOD AND DEVICE FOR EXECUTING A FUNCTION BETWEEN A PLURALITY OF ELECTRONIC DEVICES

(71) Applicant: Samsung Electronics Co., Ltd., Gyeonggi-do (KR)

(72) Inventor: Hyeon-Jin KANG, Seoul (KR)

(21) Appl. No.: 16/706,190

(22) Filed: Dec. 6, 2019

Related U.S. Application Data
(63) Continuation of application No. 14/798,784, filed on Jul. 14, 2015.

(30) Foreign Application Priority Data
Jul. 14, 2014 (KR) 10-2014-0088544

(51) Int. Cl. G06F 9/50

(52) U.S. Cl. CPC G06F 9/5055; Y02D 10/22; G06F 9/5044

(57) ABSTRACT

The present disclosure relates to a sensor network, Machine Type Communication (MTC), Machine-to-Machine (M2M) communication, and technology for Internet of Things (IoT). The present disclosure may be applied to intelligent services based on the above technologies, such as smart home, smart building, smart city, smart car, connected car, health care, digital education, smart retail, security and safety services. The present disclosure relates to method and device for executing a function, the method for executing a function in a relay device may include: receiving, from a plurality of electronic devices, capability value information on at least one function executable in each of the plurality of electronic devices; determining at least one electronic device to perform the at least one function based on the received capability value information; and transmitting at least one command message instructing an execution of the at least one function to the at least one electronic device.

### CROSS-REFERENCE TO RELATED APPLICATION

This application is a Continuation Application of U.S. patent application Ser. No. 14/798,784, filed on Jul. 14, 2015 in the United States Patent and Trademark Office, which claimed priority under 35 U.S.C. § 119(a) to Korean Application Serial number 10-2014-0088544, which was filed in the Korean Intellectual Property Office on Jul. 14, 2014, the entire content of which is hereby incorporated by reference.

### TECHNICAL FIELD

The present disclosure relates to a method and device for executing functions of a plurality of electronic devices.

### BACKGROUND

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched.

Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

With the development of a communication technology, there is a tendency that a user owns a plurality of electronic devices, and the same function can be provided by a plurality of electronic devices that the user owns. As an example, a particular user may own a smart phone, a smartwatch, Smart glasses, a Bluetooth headset, a smart light bulb and a smart speaker with network connectivity, altogether. In this regard, when a call reception event occurs on the user's smart phone, a notification on the same call reception may be generated individually on the smart phone, the smartwatch, the Smart glasses, the Bluetooth headset, the smart light bulb, and the smart speaker. Accordingly, multiple devices owned by the user execute the same function individually, and it may be considered inefficient.

### SUMMARY

Accordingly, an embodiment of the present disclosure is to provide a method and device for function sharing and collaboration among a plurality of electronic devices.

Another embodiment of the present disclosure is to provide a method and device for determining a representative device for executing a particular function among a plurality of electronic devices.

Another embodiment of the present disclosure is to provide a method and device for determining a representative device that determines capability values for respective sharable functions of a plurality of electronic devices and executes the respective functions based on the determined capability value.

Another embodiment of the present disclosure is to provide a method and device for determining at least one electronic device capable of function sharing and collaboration in the electronic device.

According to an embodiment of the present disclosure, a method for executing or performing a function in a relay device includes: receiving, from a plurality of electronic devices, capability value information on at least one function executable in each of the plurality of electronic devices; determining at least one electronic device to perform or execute the at least one function based on the received capability value information; and transmitting at least one command message instructing an execution of the at least one function to the at least one electronic device.

According to an embodiment of the present disclosure, a method for a function in an electronic device includes: receiving, from at least one electronic device, capability value information on at least one function executable in the at least one electronic device; and determining whether to operate the electronic device for the at least one function based on the received capability value information and capability value information of the electronic device.

According to an embodiment of the present disclosure, a relay device for executing a function includes: a transceiver configured to transmit/receive signals to and from a plurality of electronic devices; and a controller configured to: receive, from the plurality of electronic devices, capability value information on at least one function executable in each of the electronic devices via the transceiver, determine at least one electronic device to perform or execute the at least one function based on the received capability value information, and transmit, to the at least one electronic device, at least one command message instructing an execution of the at least one function via the transceiver.

According to an embodiment of the present disclosure, an electronic device for executing or performing a function includes: a transceiver configured to transmit/receive a signal to and from at least one electronic device; a controller configured to: receive, from the at least one electronic device, capability value information on at least one function executable in the at least one electronic devices via the transceiver, and determine whether to operate the electronic device for each function based on the received capability value information and capability value information of the electronic device.

### BRIEF DESCRIPTION OF THE DRAWINGS

The above and other aspects, features and advantages of the present disclosure will be more apparent from the following detailed description, when taken in conjunction with the accompanying drawings, in which:

FIG. 1A is a diagram illustrating an example before performing function sharing and collaboration of a plurality of electronic devices capable of performing the same function according to an embodiment of the present disclosure;

FIG. 1B is a diagram illustrating an example after performing function sharing and collaboration of a plurality of electronic devices capable of performing the same function according to an embodiment of the present disclosure;

FIG. 2 is a diagram showing a block configuration of a relay device according to an embodiment of the present disclosure;

FIG. 3 is a diagram showing a block configuration of an electronic device according to an embodiment of the present disclosure;

FIG. 4 is a diagram illustrating a procedure for determining a representative device having a function that can be shared in a relay device according to an embodiment of the present disclosure;

FIG. 5 is a diagram illustrating a procedure for determining whether to execute a function that can be shared in an electronic device according to an embodiment of the present disclosure;

FIG. 6 is a diagram illustrating a signal flow for determining a representative device having a function that can be shared using a relay device according to an embodiment of the present disclosure;

FIG. 7 is a diagram illustrating a signal flow for determining a representative device having a function that can be shared in a specific electronic device according to an embodiment of the present disclosure;

FIG. 8 is a diagram illustrating a signal flow for determining whether to perform functions that can be shared in each of the electronic devices according to an embodiment of the present disclosure;

FIG. 9 is a diagram showing an example for identifying electronic devices capable of function sharing and collaboration in a relay device according to embodiment of the present disclosure;

FIG. 10 is a diagram illustrating an example for determining a representative having a function that can be shared in a relay device according to an embodiment of the present disclosure;

FIG. 11 is a diagram illustrating an example for determining a representative having a function that can be shared in a specific electronic device according to an embodiment of the present disclosure;

FIG. 12 is a diagram illustrating an example for determining whether to perform functions that can be shared in each of the electronic devices according to an embodiment of the present disclosure;

FIG. 13 is a diagram illustrating an example of a new electronic device involved in the function sharing according to an embodiment of the present disclosure;

FIG. 14 is a diagram illustrating an example in which a representative device changes depending on the change of the capability values of a plurality of electronic devices according to an embodiment of the present disclosure;

FIG. 15 is a diagram illustrating another example in which a representative device changes depending on the change of the capability values of a plurality of electronic devices according to an embodiment of the present disclosure;

FIG. 16 is a diagram illustrating an example of function-specific capability values of a plurality of electronic devices according to an embodiment of the present disclosure; and

FIG. 17 is a diagram illustrating an example of a user interface that determines the number of function-specific execution devices in a specific electronic device according to an embodiment of the present disclosure.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

An electronic device according to various embodiments of the present disclosure may be a device including a communication function. The electronic device according to various embodiments of the present disclosure may, for example, include at least one of a smart phone, a tablet personal computer (PC), a mobile phone, a video phone, an e-book reader, a desktop PC, a laptop PC, a netbook computer, a personal digital assistant (PDA), a portable multimedia player (PMP), a Moving Picture Experts Group (MPEG-1 or MPEG-2) Audio Layer (MP3) player, a mobile medical device, a camera, a wearable device (e.g., a head-mount-device (HMD) such as electronic glasses, electronic clothing, an electronic bracelet, an electronic necklace, an electronic appcessory, an electronic tattoo, or a smart watch), a television (TV), a digital video disc (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, medical equipment (e.g., a magnetic resonance angiography (MRA) machine, a magnetic resonance imaging (MRI) machine, a computed tomography (CT) scanner, or an ultrasonic machine), a navigation device, a global positioning system (GPS) receiver, an event data recorder (EDR), a flight data recorder (FDR), a vehicle infotainment device, electronic equipment for a ship (e.g., ship navigation equipment and a gyrocompass), avionics, security equipment, an industrial or home robot, a part of furniture or building/structure, an electronic board, an electronic signature receiving device, a projector, and various measuring instruments (e.g., a water meter, an electricity meter, a gas meter, or a wave meter), each of which includes a communication function. The electronic device according to various embodiments of the present disclosure may be a combination of one or more of the aforementioned various devices. Further, it will be apparent to those skilled in the art that the electronic device according to various embodiments of the present disclosure is not limited to the aforementioned devices.

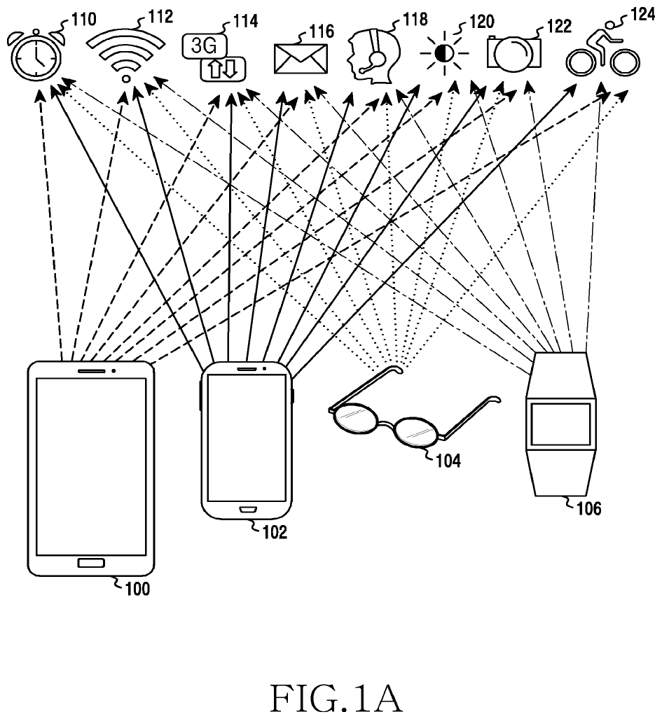

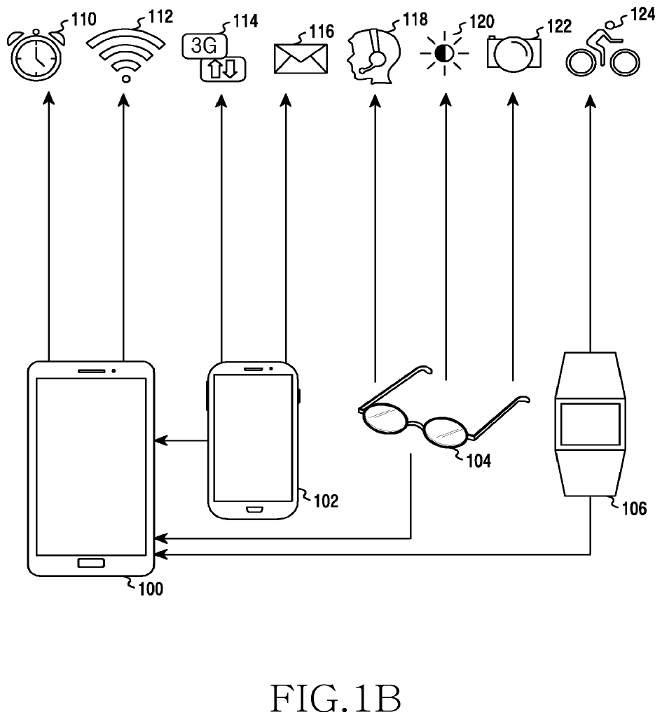

FIG. 1A is a diagram illustrating an example before performing function sharing and collaboration of a plurality of electronic devices capable of executing or performing the same function according to an embodiment of the present disclosure, and FIG. 1B is a diagram illustrating an example after performing function sharing and collaboration of a plurality of electronic devices capable of executing or performing the same function according to an embodiment of the present disclosure. In FIGS. 1A and 1B, for the convenience of explanation, it is assumed that the user owns a tablet PC, a smart phone, Smart glasses, or a smartwatch and electronic devices owned by the user may be connected with each other. However, the following description may also be applied to the user owned electronic devices different from the above-mentioned electronic devices in the same manner.

As shown in FIG. 1A, a tablet PC 100, a smart phone 102, Smart glasses 104, and a smartwatch 106 may execute a schedule notification function 110, a Wi-Fi communication function 112, a 3G communication function 114, a message notification function 116, an incoming call notification function 118, a brightness adjustment function 120, a camera function 122, and a pedometer function 124 in common. For example, when a message of a messaging service for the user's smart phone 102 is received, each of the Smart glasses 104 and the smartwatch 106 interlocked with the smart phone 102, and the smart phone 102 may perform or execute the incoming call notification function 118 in common. However, it is inefficient in terms of resource consumption and user convenience to perform or execute the same function in common by the plurality of electronic devices owned by the user.

Accordingly, an embodiment of the present disclosure may control the above-mentioned functions to be shared and effectively be executed based on the function-specific capability value information (capability value information) of each of the tablet PC 100, the smart phone 102, the Smart glasses 104, and the smartwatch 106, which are owned by the user 100. For example, in an embodiment of the present disclosure, as shown in FIG. 1B, the tablet PC 100 may be controlled to execute shareable functions, such as, for example, the schedule notifying function 110 and the Wi-Fi communication function 112, the smart phone 102 may be controlled to execute shareable functions, such as, for example, the 3G communication function 114 and the message notification function 116, the Smart glasses 104 may be controlled to execute shareable functions, such as, for example, the incoming call notification function 118, the brightness adjustment function 120 and the camera function 122, and the smartwatch 106 may be controlled shareable functions, such as, for example, to perform or execute the pedometer function 124. In another example, it is possible to determine a representative electronic device for each of the shareable functions within the group configured by a plurality of electronic devices owned by a specific user, and to allow the representative electronic device to perform or execute a corresponding function. Here, the shareable functions refer to functions that can be executed or performed in common between at least two electronic devices.

A representative device for each of the shareable functions according to an embodiment of the present disclosure may be determined based on whether each of the electronic devices (e.g., the tablet PC 100, the smart phone 102, the smart glasses 104, and the smartwatch 106 of FIG. 1B) in the group is carried, used, held, or worn, a remaining battery amount, a remaining operating time, an ambient noise level, whether vibration is set, and a frequency of use of a corresponding function. For example, for a shareable notification function, a capability value (or score) indicating how successfully the shareable notification function can be run or executed may be calculated based on whether each of the electronic devices is carried, used, held, or worn, the remaining battery amount, the remaining operating time, the ambient noise level, whether the vibration is set, and the frequency of use of the notification function, and the electronic device with the highest calculated capability value may be determined as the representative device to perform or execute the notification function.

In accordance with an embodiment of the present disclosure, representative electronic devices for each of the shareable functions may be determined based on a received capability value for each of the electronic devices after receiving, from the electronic devices in a group, a function-specific capability value information (score information), by a separate relay device (or a control device) that does not belong to the group. In accordance with another embodiment of the present disclosure, representative electronic devices for each of the shareable functions may be determined based on the received capability value for each of the electronic devices after receiving, from other electronic devices in a group, the function-specific capability value information, by a specific electronic device in the group. Here, the specific electronic device may be an electronic device that consumes a small amount of resources due to a low frequency of use by the user or an electronic device having the largest battery capability among the electronic devices in the group. According to another embodiment, it may be determined which electronic device belonging to the group is operated as a representative device for the function, after exchanging each of the function-specific capability value information among the electronic devices.

According to an embodiment of the present disclosure, a group which is configured by a plurality of electronic devices may include all electronic devices included in a preconfigured list of interworking devices. The group configured by a plurality of electronic devices according to another embodiment of the present disclosure may be configured by electronic devices detected using a peripheral device detection function of a specific communication method (e.g., Bluetooth) among the electronic devices included in the preconfigured list of interworking devices. Further, the group configured by a plurality of electronic devices according to another embodiment of the present disclosure may be configured by electronic devices which have similar mobility among the electronic devices included in the preconfigured list of interworking devices. Here, the mobility may include moving direction, moving speed, current position information and the like.

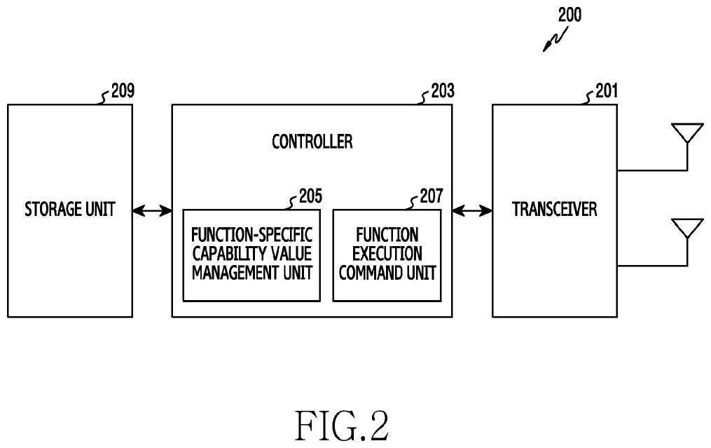

FIG. 2 shows a block diagram of a relay device 200 according to an embodiment of the present disclosure.

Referring to FIG. 2, the relay device 200 may be configured to include a transceiver 201, a controller 203, and a storage unit 209. Here, the relay device 200 is a separate electronic device that does not belong to a group, and may perform the role of a relay device for a plurality of groups. In addition, the relay device 200 is any one of the plurality of devices belonging to a group (e.g., the group of FIG. 1A and FIG. 1B), and may perform the role of a relay device for the group.

The transceiver 201 may transmit and receive a signal to and from at least one electronic device according to the control of the controller 203. For example, the transceiver 210 may receive, from the at least one electronic device, a function-specific capability value, function-specific capability value information, or function-specific capability score information, of the electronic device and may transmit, to a specific electronic device, a signal for instructing to operate as a representative device for a particular function according to the control of the controller 203. The transceiver 201 according to an embodiment may be divided into a transmitting unit (not shown) and a receiving unit (not shown). In addition, the transceiver 201 may include a communication modem (not shown) which supports a plurality of communication schemes, or include multiple communication modems (not shown) that support different communication schemes.

The controller 203 controls and processes the overall operations of the relay device 200. The controller 203 may include a function-specific capability value management unit 205 and a function execution command unit 207, may receive, from a plurality of electronic devices included in a specific group, capability value information indicating a capability value of each of the shareable functions, may determine a representative electronic device for each shareable function, on the basis of the capability value information for each of the shareable functions of the plurality of electronic devices, and may transmit, to a representative electronic device for each shareable function, a signal for instructing to operate as a representative electronic device for the shareable function.

In more detail, when the function-specific capability value management unit 205 receives the capability value information indicating capability values for the shareable functions from a specific electronic device, the function-specific capability value management unit 205 determines whether a function-specific capability value table for a group of a specific electronic device is present in the storage unit 209. When the function-specific capability value table for a group of a specific electronic device is present, the function-specific capability value management unit 205 may add or update the function-specific capability value information of a particular electronic device to the function-specific capability value table of the group. When the function-specific capability value table for a group of specific electronic devices is not present, the function-specific capability value management unit 205 may create a function-specific capability value table for a new group and add the function-specific capability value information of the specific electronic device to the function-specific capability value table for the new created group. Here, the function-specific capability value management unit 205 may receive group identification information from a specific electronic device and then identify the group of the specific electronic device, and may compare the identification information of a specific electronic device with a list of groups that are stored in advance and then identify the group of the specific electronic device. For example, the list of the groups may be a list indicating the identification information of electronic devices included in each group.

The function execution command unit 207 is controlled on a regular basis, or at each time when the function-specific capability value table for each group is updated by the function-specific capability value management unit 205, to determine a representative device for each function, and to transmit, to the determined representative device, a signal for instructing to operate as the determined representative device of the function. Here, the function execution command unit 207, based on the capability value of the particular functions of the electronic devices in each group, may determine the representative device for a particular function. In addition, the function execution command unit 207 may determine one electronic device having the highest capability value for a particular function as a representative device, and may determine a predetermined number of electronic devices as representative devices in a sequence of higher capability values relative to other electronic devices, e.g., in a group.

Further, when determining the function-specific representative device of each group, the controller 203 may determine representative devices based on interworking-possible conditions of the electronic devices belonging to each group. For example, based on the mobility of electronic devices belonging to a particular group, the controller 203 may identify electronic devices that are adjacent to each other, regard or designate the electronic devices adjacent to each other as devices capable of the function sharing, and determine a representative device for each function among the electronic devices adjacent to each other. Here, the mobility may include moving direction, moving speed, current position information and the like.

The storage unit 209 stores various data and programs for the overall operation of the relay device 200. The storage unit 209 stores and manages, based on the control of the controller 203, the function-specific capability value table (not shown) for at least one group.

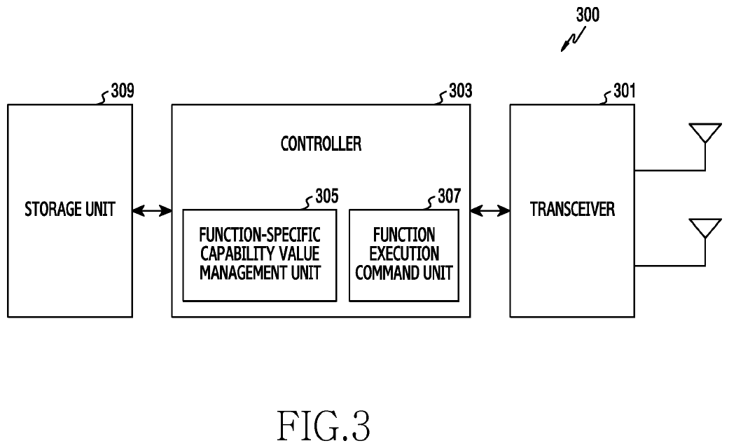

FIG. 3 shows a block diagram of an electronic device according to an embodiment of the present disclosure.

Referring to FIG. 3, an electronic device 300 may be configured to include a transceiver 301, a controller 303, and a storage unit 309.

The transceiver 301, based on the control of the controller 303, may transmit and receive a signal to and from at least one electronic device (e.g., the tablet PC 100, the smart phone 102, the Smart glasses 104, and the smartwatch 106 of FIG. 1B) and/or a relay device (e.g., the relay device 200 of FIG. 2). For example, the transceiver 301 may receive function-specific capability value information (or score information) on the electronic device from the at least one electronic device. As another example, the transceiver 301 may receive, from the relay device, a signal indicating an execution of a particular function or a representative device that performs or executes a particular function. Further, as another example, when the electronic device 300 performs the role of a relay device, the transceiver 301 may receive, from the at least one electronic device, a function-specific capability value, function-specific capability value information, or function-specific capability score information, of the electronic device and may transmit, to a specific electronic device, a signal for instructing to operate as a representative device for a particular function according to the control of the controller 303. Furthermore, as another example, the transceiver 301 may transmit, to the at least one other electronic device or the relay device, function-specific capability value information of the electronic device 300 which is determined on the basis of the control of the controller 303. According to an embodiment, the transceiver 301 may be divided into a transmitting unit (not shown) and a receiving unit (not shown). In addition, the transceiver 301 may include one communication modem (not shown) which supports a plurality of communication schemes, or multiple communication modems that support different communication schemes.

The controller 303 controls and processes the overall operations of the electronic device 300. The controller 303 may include a function-specific capability value management unit 305 and a function execution command unit 307, and may operate as a representative device that performs a particular function by comparing the capability value information indicating a capability value for each of the functions of the electronic device 300 and capability value information indicating the capability value for each of the functions received from the plurality of electronic devices. Further, the controller 303 may operate as a representative electronic device that performs or executes a particular function by receiving the execution command for a particular function from the relay device. According to an embodiment, how the electronic device operates as a representative device for a particular function may imply that the electronic device among a plurality of electronic devices may detect whether the electronic device is in a situation requiring execution of a particular function and execute the particular function when it is in the situation requiring the execution of the particular function.

In more detail, the function-specific capability value management unit 305 may determine the capability value information indicating capability values for each of a plurality of shareable functions which can be performed or executed by the electronic device 300. In particular, the function-specific capability value management unit 305 may determine the capability value information only for functions that can be shared by the electronic device 300 and other electronic devices. The function-specific capability value management unit 305 may pre-configure and store function-specific capability value information, and update the capability value information every time that a factor determining the capability value information is changed for each function. For example, the function-specific capability value management unit 305 may determine and/or update the capability values for each of the shareable functions based on elements such as, whether the electronic device is carried, used, held, or worn, a remaining battery amount, a remaining operating time, an ambient noise level, whether a vibration function is set, and a frequency of use of a corresponding function. In this regard, the elements considered in order to determine and/or update the capability value may be different for each function. For example, the function-specific capability value management unit 305 may increase or decrease the capability value information for a pedometer function (e.g., the pedometer function 124 of FIG. 1B) according to whether the electronic device 300 is carried, used, held, worn or not. If the electronic device 300 corresponds to a smartwatch (e.g., the smartwatch 106 of FIG. 1B) which executes the pedometer function representatively, and when the function-specific capability value management unit 305 detects the detachment of the smartwatch, the function-specific capability value management unit 305 may determine that it is difficult to perform or execute the functions of the pedometer by the smartwatch, and may decrease the capability value information on the pedometer function of the smartwatch. Whereas, when the function-specific capability value management unit 305 detects that the smartwatch is carried, used, held, or worn, it may increase the capability value information on the pedometer functions of the smartwatch. As another example, the function-specific capability value management unit 305 may increase or decrease the capability value on the vibration function for a message notification function (e.g., the message notification function 116 of FIG. 1B) according to the battery remaining amount of the electronic device 300. If the battery remaining amount of the electronic device 300 decreases from 53% to 52%, the function-specific capability value management unit 305 may decrease the capability value on the vibration function for the message notification function from 53 to 52. On the other hand, if the battery remaining amount increases from 54% to 55%, the function-specific capability value management unit 305 may increase the capability value on the vibration function for message notification from 54 to 55. In another example, the function-specific capability value management unit 305 may decrease the capability value on the vibration function for message notification in inverse proportion to a battery use time of the electronic device 300. In another example, the function-specific capability value management unit 305 may increase or decrease the capability value on a sound notification function according to ambient noise information. If the maximum intensity of the sound notification function that can be output from the electronic device 300 is 65 dB and the intensity of the ambient noise is 60 dB, the function-specific capability value management unit 305 may increase the capability value on the sound notification function since the maximum intensity of the sound notification function that can be output from the electronic device 300 is larger than the intensity of ambient noise. On the other hand, when the maximum intensity of the sound notification that can be output from the electronic device 300 is 65 dB and the intensity of the ambient noise is 80 dB, the function-specific capability value management unit 305 may decrease the capability value information on the sound notification since the intensity of ambient noise is greater than the maximum intensity of the sound notification function that can be output from the electronic device 300. In another example, the function-specific capability value management unit 305, depending on an accumulated number of uses for the respective shareable functions, may increase or decrease the function-specific capability value. The function-specific capability value table of the electronic device 300, in addition to the methods described above, may be determined in accordance with the conditions or elements that can be changed by the electronic device 300.

Furthermore, the function-specific capability value management unit 305 may determine the function-specific capability value or function-specific capability value information on the electronic device 300 through a combination of the one or more methods described above. For example, the function-specific capability value management unit 305 may determine the capability value for the pedometer function based on whether the electronic device is carried, used, held, or worn, a remaining battery amount, and previously input capability value information. When a wearing of the electronic device 300 is detected, the battery remaining amount is 60%, and the previously input capability value corresponds to 50, the function-specific capability value management unit 305 may determine the capability value for the pedometer function of the electronic device 300 as 1×60×50=3000. On the other hand, when a detachment of electronic device 300 is detected, the battery remaining amount is 60%, and the previously input capability value corresponds to 50, the function-specific capability value management unit 305 may determine the capability value for the pedometer function of the electronic device 300 as 0×60×50=0.

Furthermore, the function-specific capability value management unit 305 may be configured, in order to prevent the elements determining the capability value from being frequently changed, or in the case that elements determining the capability value are changed to an extent larger than a threshold value, the function-specific capability value management unit 305 may be configured to update the capability value at a preset period.

The function-specific capability value management unit 305, when receiving from the specific electronic device at least one piece of capability value information indicating the capability value for the particular shareable function may check whether a function-specific capability value table of the electronic device 300 for the shareable function exists. When the function-specific capability value table for the function is present, the function-specific capability value management unit 305 may add or update the capability value information on the shareable function of the specific electronic device to the function-specific capability value table for the shareable function.

The function execution command unit 307, on a regular basis, or every time that the function-specific capability value table is updated by the function-specific capability value management unit 305, may determine whether the electronic device 300 is a representative device for each function. When the electronic device 300 is determined as the representative device, the function execution command unit 307 can be controlled to perform or execute the shareable function. Here, the function execution command unit 307 may determine the electronic device 300 as a representative device for the particular function, based on the capability values for the particular functions of other electronic devices and the capability value for the particular function of the electronic device 300. For example, when the capability value on the message vibration notification function of each of the electronic devices received from the first electronic device and the second electronic device are 3000 and 4000, respectively, and when the capability value for the message vibration notification function of the electronic device 300 corresponds to 5000, the function execution command unit 307 determines the electronic device 300 as a representative device for the message vibration notification function and performs or executes the message vibration notification function. For another example, when the capability value on the message vibration notification function of each of the electronic devices received from the first electronic device and the second electronic device are 3000 and 4000, respectively, and when the capability value for the message vibration notification function of the electronic device 300 is 3500, the function execution command unit 307 may not perform or execute the message vibration notification function of the electronic device 300.

Further, when receiving an execution command for a particular function from a relay device (e.g., the relay device 200 of FIG. 2), or when receiving a signal indicating that the electronic device 300 is the representative device for the particular function, the function execution command unit 307 may perform or execute the particular function. For example, the function execution command unit 307, when receiving from the relay device the execution command on the schedule notification function, may perform or execute the schedule notification function.

Furthermore, the function execution command unit 307 according to an embodiment of the present disclosure, when the electronic device 300 is configured as a representative device for a particular function, and when receiving from another electronic device 300 capable of sharing functions a function execution input rather than a function execution command, the function execution command unit 307 may perform or execute the function on the electronic device 300. For example, in a state in which the electronic device 300 is set as a representative device for a photographing function (e.g., the camera function 122 of FIG. 1B), when a photographing input is received from another electronic device rather than a representative device capable of function sharing, the function execution command unit 307 may perform or execute the photographing function of the electronic device 300.

The storage unit 309 stores various data and programs for the overall operations of the relay device. The storage unit 309 stores and manages, based on the control of the controller 303, at least one function-specific capability value table.

As described above, an embodiment of the present disclosure may determine a representative device for each function based on the function-specific capability value which can be shared by each of the electronic devices or the relay device, and the determined representative device may perform or execute the function. In this regard, each of the electronic devices, for the functions that are not determined as the representative device, can have the advantage of saving resource consumption by not performing the function.

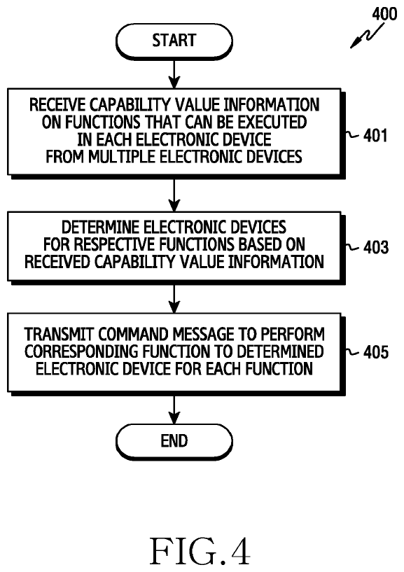

FIG. 4 is a diagram illustrating a procedure 400 for determining a representative device of functions that can be shared in a relay device according to an embodiment of the present disclosure.

Referring to FIG. 4, in step 401, the relay device 200 may receive from a plurality of electronic devices (e.g. the tablet PC 100, the smart phone 102, the Smart glasses 104, and the smartwatch 106 of FIG. 1B) capability value information on functions that can be executed in each electronic device. That is, the relay device 200 may receive, from a plurality of electronic devices included in a specific group, a capability value, capability value information, or capability score information, indicating capability values for each of the functions that can be shared. For example, the relay device 200 (of FIG. 2) may receive information indicating that the capability value on a pedometer function that can be shared from a first electronic device, a second electronic device, and a third electronic device are 3000, 4000, and 5000, respectively.

Thereafter, the procedure 400 proceeds to step 403 and the relay device 200 may determine the electronic devices for the respective functions based on the received capability value information. In addition, the relay device 200 may determine one electronic device having the highest capability value for respective functions as a representative device, and may determine a predetermined number of electronic devices as representative devices in a sequence of higher ranked capability values. For example, the relay device 200 may determine the third electronic device having the highest capability value for a pedometer function as a representative device for a pedometer function. As another example, the relay device 200 may determine the third electronic device having the highest capability value for the pedometer function and the second electronic device with the second highest capability value for the pedometer function as representative devices for the pedometer function.

Thereafter, in step 405, the relay device 200 may transmit to the determined electronic device for each function a command message to perform or execute the function. For example, when the third electronic device is determined or designated as the representative device for the pedometer function, the relay device 200 transmits, to the third electronic device, the command message instructing an execution of the pedometer function. For another example, when the third electronic device and the second electronic device are determined or designated as the representative devices for the pedometer function, the relay device 200 transmits, to the third electronic device and the second electronic device, the command message instructing an execution of the pedometer function.

Thereafter, the controller 200 may terminate a procedure according to an embodiment of the present disclosure.

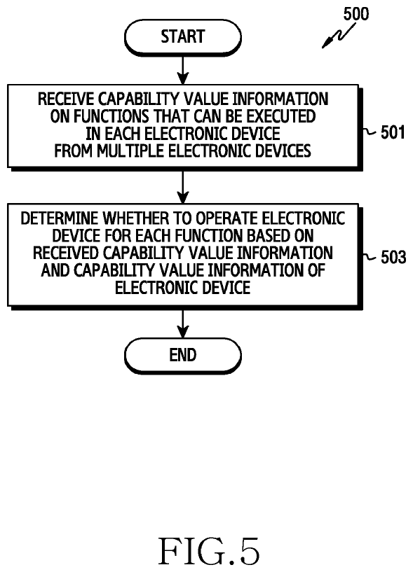

FIG. 5 is a diagram illustrating a procedure 500 for determining whether to execute functions that can be shared in an electronic device according to another embodiment of the present disclosure.

Referring to FIG. 5, in step 501, the electronic device 300 (of FIG. 3) may receive from a plurality of electronic devices (e.g., the tablet PC 100, the smart phone 102, the Smart glasses 104, and the smartwatch 106 of FIG. 1B) the capability value information on functions that can be executed in each electronic device. That is, the electronic device 300 may receive the capability value information on functions that can be shared by the electronic device 300 and multiple other electronic devices. For example, the relay device 200 (of FIG. 2) may receive information indicating that the capability value information on a pedometer function that can be shared from a first electronic device, a second electronic device, and a third electronic device are 3000, 4000, and 5000, respectively.

Thereafter, the electronic device 300, in step 503, may determine whether to operate each function on the basis of the received capability value information and the capability value information of the electronic device 300. That is, the electronic device 300 may decide whether to operate each function by comparing the capability value information of the plurality of electronic devices received from the plurality of electronic devices and the capability value information of the electronic device 300. For example, the electronic device 300 may compare the information indicating that the capability values for the pedometer function received from the first electronic device, the second electronic device, and the third electronic device are 3000, 4000, and 5000, respectively, and the information indicating that the capability value for the pedometer function of the electronic device 300 is 6000, may identify the highest capability value information of the electronic device 300, and may perform or execute the pedometer function of the electronic device 300. As another example, when the capability values for the pedometer function of the first electronic device, the second electronic device, and the third electronic device are 3000, 4000, and 5000, respectively, and the capability value for the pedometer function of the electronic device 300 corresponds to 4000, since the capability value on the pedometer function of the electronic device 300 is not the highest value, the electronic device 300 may not run or execute the pedometer function.

Thereafter, the controller 300 may terminate a procedure according to an embodiment of the present disclosure.

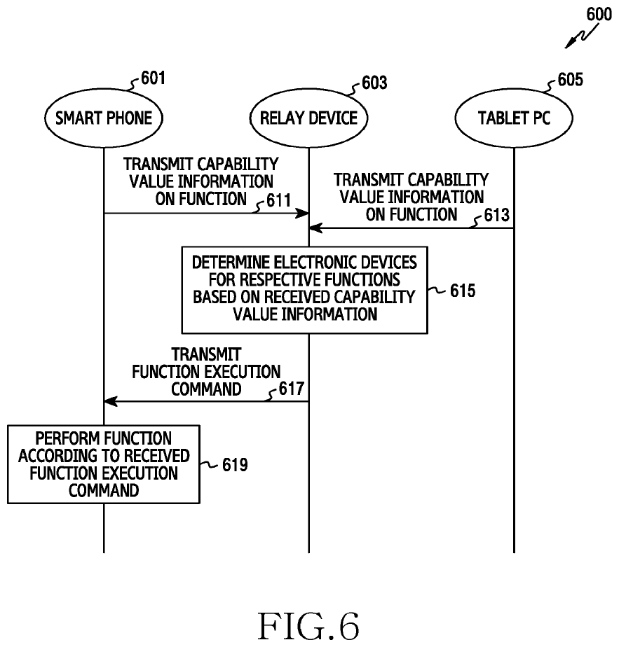

FIG. 6 is a diagram illustrating a signal flow process 600 for determining a representative having a function that can be shared, using a relay device 603 (similar to the relay device 200 of FIG. 2), according to an embodiment of the present disclosure. In FIG. 6, for the convenience of explanation, it is assumed that the user has a smart phone 601 (similar to the smart phone 102 of FIG. 1B) or a tablet PC 605 (similar to the tablet PC 100 of FIG. 1B). In addition, the relay device of FIG. 6 is assumed to be the device which is in charge of only the role of the relay, without executing or performing functions directly.

Referring to FIG. 6, in operation 611, the smart phone 601 may transmit capability value information on a particular function to the relay device 603. According to an embodiment, the smart phone 601 may transmit the capability value information to the relay device 603 every time that the capability value information on the particular function is updated. According to another embodiment, the smart phone 601 may periodically transmit the function-specific capability value information to the relay device 603.

In addition, in operation 613, the tablet PC 605 may transmit the capability value information on a particular function to the relay device 603. In this regard, the tablet PC 605 may also transmit the capability value information to the relay device 603 every time that the capability value information on the particular function is updated, and may periodically transmit the function-specific capability value to the relay device 603. At this time, the capability value information transmitted to the relay device 603 by the smart phone 601 and the tablet PC 605 may be the capability value information on the same functions. For example, the capability value information transmitted to the relay device 603, by the smart phone 601 and the tablet PC 605, may be the capability value information on the message notification function. According to another embodiment, the smart phone 601 and the tablet PC 605 may also transmit, to the relay device 603, the capability value information on functions different from each other.

Thereafter, the process 600 proceeds to step 615 and the relay device 603 may determine one or more representative electronic devices for the respective functions based on the received capability value information. That is, the relay device 603 may compare the received capability value information on particular functions with each other and determine which of the electronic devices is to perform or execute the functions. For example, the relay device 603 may compare the capability value information for the message notification function received from the smart phone 601 and the tablet PC 605 with each other, and may determine the electronic device having the highest capability value information among the smart phone 601 and the tablet PC 605 as an electronic device for executing a message notification function.

Thereafter, the process 600 proceeds to step 617 and the relay device 603 may transmit the function execution command to the smart phone 601. That is, the relay device 603, when an electronic device for the particular function is determined or designated, may transmit the function execution command to the determined or designated electronic device. For example, the relay device 603, when the electronic device for the message notification function is determined or designated as the smart phone 601, may transmit the message notification function execution command to the smart phone 601.

Thereafter, the process 600 proceeds to step 619 and the smart phone 601 may perform or execute the function according to the received function execution command. For example, the smart phone. 601, when the received function execution command is a message notification function (similar to the message notification function 116 of FIG. 1B) execution command, may perform or execute the message notification function.

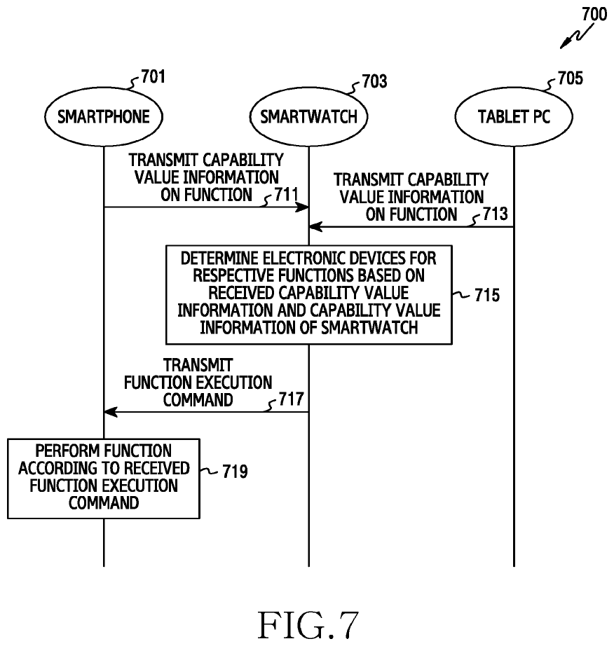

FIG. 7 is a diagram illustrating a signal flow process 700 for determining a representative having a function that can be shared in a particular electronic device according to an embodiment of the present disclosure. In FIG. 7, for the convenience of explanation, it is assumed that the user has a smart phone 701 (similar to the smart phone 102 of FIG. 1B), a smartwatch 703 (similar to the smartwatch 106 of FIG. 1B), and a tablet PC 705 (similar to the tablet PC 100 of FIG. 1B). Further, the smartwatch in FIG. 7 may be assumed to be an electronic device which may play the role of a relay device at the same time while executing or performing at least one function that can be shared.

Referring to FIG. 7, in operation 711, the smart phone 701 may transmit the capability value information on a particular function to the relay device 703. In this regard, the smart phone 701 may recognize that the smartwatch 703 is being operated as a relay device, and may transmit the capability value information to the smartwatch 703 every time that the capability value information of the particular function is updated. In addition, in operation 713, the tablet PC 705 may transmit capability value information on a particular function to the smartwatch 703. At this time, the tablet PC 705 may recognize that the smart watch 703 plays a role of a relay device, and may transmit the capability value information to the smart watch 703 every time that the capability value information of the particular function is updated. In this regard, the capability value information transmitted to the smartwatch 703, by the smart phone 701 and the tablet PC 705, may be the capability value information on the same shareable functions. For example, the capability value information transmitted to the smartwatch 703, by the smart phone 701 and the tablet PC 705, may be the capability value information on an incoming phone call notification function (e.g., the incoming call notification function 118 of FIG. 1B). According to another embodiment, the smart phone 701 and the tablet PC 705 may also transmit, to the smartwatch 703, different capability value information on different functions. The smart phone 701 and the tablet PC 705 may recognize that the smartwatch 703 operates as a relay device by receiving, from the user input or the smartwatch 703, a signal indicating that the smart watch 703 is operating as a relay device. According to another embodiment, the smart phone 701 and the tablet PC 705 may determine or designate a relay device through negotiations with multiple electronic devices owned by the user, and may recognize that the smart watch 703 operates as the relay device, as a result of the negotiations. For example, multiple electronic devices owned by the user may determine or designate one or more of the electronic devices to be operated as the relay device or relay devices through a negotiation procedure for exchanging information with each other, such as a battery remaining amount, and/or the user's frequency of use.

Thereafter, the process 700 proceeds to step 715 and the smartwatch 703 may determine or designate one or more of the electronic devices for the respective functions based on received capability value information and the capability value information of the smartwatch 703. In other words, the smartwatch 703 may compare the received capability value information on the smart phone 701 and the tablet PC 705 for a particular function and the capability value information of the smartwatch 703 for a particular function, and then determine or designate the electronic device to execute the function. For example, the smartwatch 703 may compare the capability value information for an incoming telephone notification function (e.g., the incoming call notification function 118 of FIG. 1B) received from the smart phone 701 and the tablet PC 705 and the capability value information on the incoming phone call notification function of the smartwatch 703, and then may determine or designate the electronic device with the highest capability information as the electronic device for executing the incoming call notification function.

Thereafter, the process 700 proceeds to step 717 and the smartwatch 703 may transmit the shareable function execution command to the smart phone 701. In other words, when an electronic device for a particular function has been determined or designated, the smart watch 703 may transmit the function execution command to the determined or designated electronic device. For example, when an electronic device for an incoming phone call notification function (e.g., the incoming call notification function 118 of FIG. 1B) is determined or designated to be the smart phone 701, the smartwatch 703 may transmit an incoming phone call notification function execution command to the smart phone 701.

Thereafter, the process 700 proceeds to step 719 and the smart phone 701 may perform or execute the function according to the received function execution command. For example, when the received function execution command is an incoming phone call notification function execution command (e.g., from the tablet PC 705), the smart phone 701 may perform or execute the incoming phone call notification function.

If the electronic device for a particular function is the smartwatch 703, the smartwatch 703 may perform or execute the particular function on the smartwatch 703 without transmitting the function execution command to another electronic device. For example, when the smartwatch 703 is determined or designated as an electronic device of the incoming phone call notification function, the smartwatch 703 may operate as a device that is responsible for the execution of the incoming call notification function.

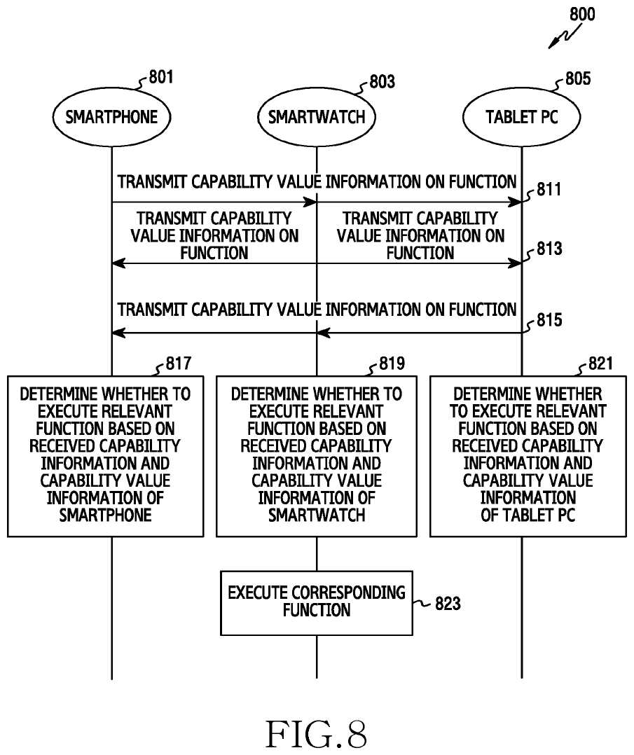

FIG. 8 is a diagram illustrating a signal flow process 800 for determining whether to perform or execute a function that can be shared in each electronic device according to an embodiment of the present disclosure.

Referring to FIG. 8, for the convenience of explanation, it is assumed that the user has a smart phone 801 (similar to the smart phone 102 of FIG. 1B), a smartwatch 803 (similar to the smartwatch 106 of FIG. 1B), and a tablet PC 805 (similar to the tablet PC 100 of FIG. 1B). In addition, FIG. 8 assumes that there are no other electronic devices performing the role of a relay device.

Referring to FIG. 8, in operation 811, the smart phone 801 may transmit capability value information on a particular function to the smartwatch 803 and the tablet PC 805 interlocked with the smart phone 801. In this regard, the smart phone 801 may transmit the capability value information to the smartwatch 803 and the tablet PC 805 every time that the capability value information for the particular function is updated, or alternatively, may periodically transmit to the interlocked smartwatch 803 and tablet PC 805, the capability value information for each of the functions that can be shared.

Thereafter, in step 813, the smartwatch 803 may transmit the capability value information on the particular function to the smart phone 801 and the tablet PC 805 interlocked with the smartwatch 803. In this regard, the smartwatch 803 may transmit the capability value information to the smart phone 801 and the tablet PC 805 every time that the capability value information for the particular function is updated, or alternatively, may periodically transmit, to the interlocked smartwatch 801 and the tablet PC 805, the capability value information for each of the functions that can be shared.

Thereafter, in step 815, the tablet PC 805 may transmit the capability value information on the particular function to the smart phone 801 and the smartwatch 803 interlocked with the tablet PC 805. In this regard, the tablet PC 805 may transmit the capability value information to the smart phone 801 and the smartwatch 803 every time that the capability value information for the particular function is updated, or alternatively, periodically transmit, to the interlocked smartwatch 801 and the interlocked smartwatch 803, the capability value information for each of the functions that can be shared.

According to an embodiment, through steps 811 to 815, the capability value information on a particular function exchanged with each other by the smart phone 801, the smartwatch 803, and the tablet PC 805 may be capability information on the same function. For example, the capability value information transmitted by the smart phone 801, the smartwatch 803, and the tablet PC 805 may be capability value information on a pedometer function (e.g., the pedometer function 116 of FIG. 1B). In addition, the smart phone 801, the smartwatch 803 and the tablet PC 805, through steps 811 to 815, may also exchange the capability value information on different functions from each other.

Thereafter, the smart phone 801, the smartwatch 803, and the tablet PC 805 proceed to steps 817, 819, 821, respectively, and may determine whether to execute a function based on the received capability value information and their own capability value information. More specifically, in step 817, the smart phone 801 may determine whether to perform or execute a pedometer function (e.g., the pedometer function 124 of FIG. 1B) for the smart phone 801 based on the capability value information on the pedometer function received from the smartwatch 803 and the tablet PC 805 and the capability value information on the pedometer function of the smart phone 801. More specifically, in step 819, the smartwatch 803 may determine whether to perform or execute a pedometer function for the smartwatch 803 based on the capability value information on the pedometer function received from the smart phone 801 and the tablet PC 805 and the capability value information on the pedometer function of the smartwatch 803. In step 821, the tablet PC 805 may determine Whether to perform or execute a pedometer function for the tablet PC 805 based on the capability value information on the pedometer function received from the smart phone 801 and the smartwatch 803 and the capability value information on the pedometer function of the tablet PC 805.

Thereafter, the process 800 proceeds to step 823 and the smartwatch 803 may perform or execute the corresponding function. In other words, as a result of comparing the received capability value information on another electronic device and the capability value information of the smartwatch 803, and when the capability value information of the smartwatch 803 is the highest, the smartwatch 803 may perform or execute a function corresponding to the capability value information. For example, as a result of comparing the received capability value information on the pedometer function of another electronic device and the capability value information on the pedometer function of the smartwatch 803, and when the capability value information on the pedometer function of the smartwatch 803 is the highest, the smartwatch 803 may perform or execute on the pedometer function.

At this time, the smart phone 801 and the tablet PC 805, as a result of comparing the capability value of the functions, may ensure that the highest capability value is the capability value of the smartwatch 803, and thus may not perform or execute the function corresponding to the capability value.

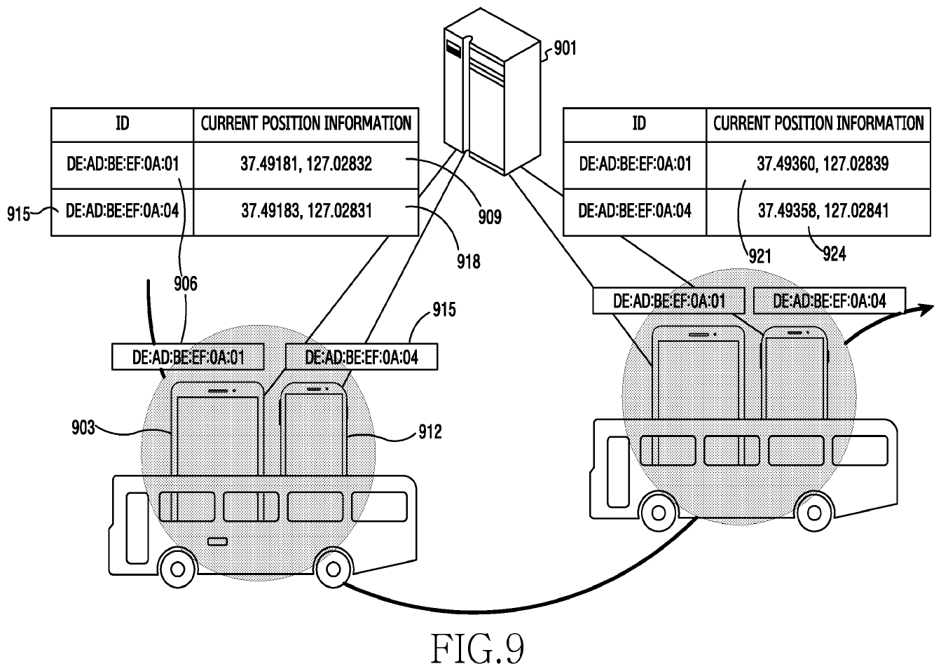

FIG. 9 is a diagram showing an example for identifying an electronic device capable of function sharing and collaboration in a relay device 901 according to embodiment of the present disclosure.

Referring to FIG. 9, the relay device 901 may designate the electronic devices having similar mobility among electronic devices included in a pre-configured list of interworking devices as a group, such that the function sharing may be possible between devices included in the group. At this time, exemplary types of mobility may include a moving direction, a moving speed, and current position information, etc. of an electronic device.

The relay device 901 may receive, e.g., from a tablet PC 903 (e.g., similar to the tablet PC 100 of FIG. 1B), a signal indicating that an identity (ID) 906 of the tablet PC 903 is DE:AD:BE:EF:0A:01 with a current position 909 of 37.49181, 127.02832, and may receive, from the tablet PC 903, a signal indicating that an ID 915 of a smart phone 912 (e.g., similar to the smart phone 102 of FIG. 1B) is DE:AD:BE:EF:0A:04 with a current position 918 of 37.49183, 127.02831. In addition, the relay device 901, after a predetermined time has elapsed, may receive a signal indicating that the current position 921 is 37.49360, 127.02839 from the tablet PC 903, and may receive a signal indicating that a current position 924 of 37.49358, 127.02841 from the smart phone 912. The relay device 901 may determine that the mobility of the tablet PC 903 is similar to the mobility of the smart phone 912 based on the respective current position information received from the tablet PC 903 and the smart phone 912, designate both the tablet PC 903 and the smart phone 912 in a group, and determine that function sharing is possible between the tablet PC 903 and the smart phone 912 included in the group.

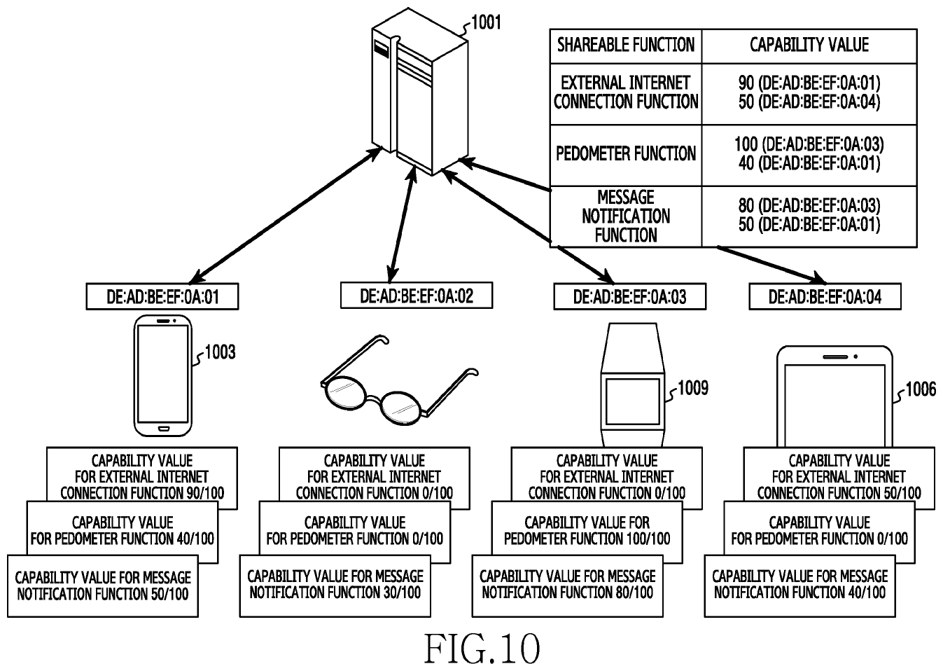

FIG. 10 is a diagram illustrating a signal flow for determining a representative electronic device having a function that can be shared through a relay device 1001 according to an embodiment of the present disclosure.

Referring to FIG. 10, the relay device 1001 may receive, from a plurality of electronic devices that belong to a particular group, capability value information on an external Internet connection function, a pedometer function and a message notification function, and may create and store a function-specific capability value table indicating the capability value of the external Internet connection function, the pedometer function and the message notification function of the plurality of electronic devices belonging to the particular group. At this time, the function-specific capability value table can be updated every time that the capability value information on at least one of the external Internet connection function, the pedometer function and the message notification function is received from one of the electronic devices.

Firstly, the relay device 1001 may check, in the function-specific capability value table, the capability value on the external Internet connection function of an electronic device (e.g., a smart phone 1003) having an ID of DE:AD:BE:EF:0A:01, is 90, and the capability value on the external Internet connection function of an electronic device (e.g., a tablet PC 1006) having an ID of DE:AD:BE:EF:0A:04, corresponds to 50. The relay device 1001 may determine that the ID of an electronic device having the highest capability value for the external Internet connection function is DE:AD:BE:EF:0A:01, and transmit, to the electronic device (the smart phone 1003) having the corresponding ID, a signal indicating that the electronic device (the smart phone 1003) has been designated as a representative electronic device for receiving an external Internet connection function execution command or the external Internet connection function. The electronic device (the smart phone 1003) having the ID of DE:AD:BE:EF:0A:01 may receive a signal indicating that the electronic device (the smart phone 1003) has been designated as a representative device for receiving the external Internet connection function execution command or the external internet connection function, and may immediately execute the external Internet connection function, or may detect whether it is a situation requiring the external Internet connection function and execute the external Internet connection function.

Further, the relay device 1001 may check, in the function-specific capability value table, the capability value on a pedometer function of the electronic device (e.g., a smartwatch 1009) having an ID of DE:AD:BE:EF:0A:03, corresponds to 100, and the capability value on the external Internet connection function of the electronic device (e.g., the smart phone 1003) having the ID of DE:AD:BE:EF:0A:01, corresponds to 40. Thereafter, the relay device 1001 may determine that the ID of the electronic device having the highest capability value for the pedometer function is DE:AD:BE:EF:0A:03, and transmit, to the electronic device (e.g., the smartwatch 1009) having the corresponding ID, a signal indicating that the electronic device (e.g., the smartwatch 1009) has been designated as a representative device for the pedometer function or receiving a pedometer function execution command. The electronic device (e.g., the smartwatch 1009) having the ID of DE:AD:BE:EF:0A:03 may receive the pedometer function execution command and immediately execute the pedometer function, or may detect whether it is a situation requiring the pedometer function and execute the pedometer function.

Furthermore, the relay device 1001 may also check, in the function-specific capability value table, the capability value on a message notification function of the electronic device (e.g., the smartwatch 1009) having the ID of DE:AD:BE:EF:0A:03, corresponds to 80, and the capability value on the message notification function of the electronic device (e.g., the smart phone 1003) having the ID of DE:AD:BE:EF:0A:01, corresponds to 50. Thereafter, the relay device 1001 may check that the ID of the electronic device with the highest capability value for the message notification function is DE:AD:BE:EF:0A:03, and transmit, to the electronic device (e.g., the smartwatch 1009) having the corresponding ID, a signal indicating that the electronic device (e.g., the smartwatch 1009) has been designated as a representative device for the message notification function or receiving a message notification function execution command. The electronic device (e.g., the smartwatch 1009) having the corresponding ID of DE:AD:BE:EF:0A:03 may receive the message notification function execution command and immediately execute the message notification function, or may detect whether it is a situation requiring the message notification function execution and execute the message notification function.

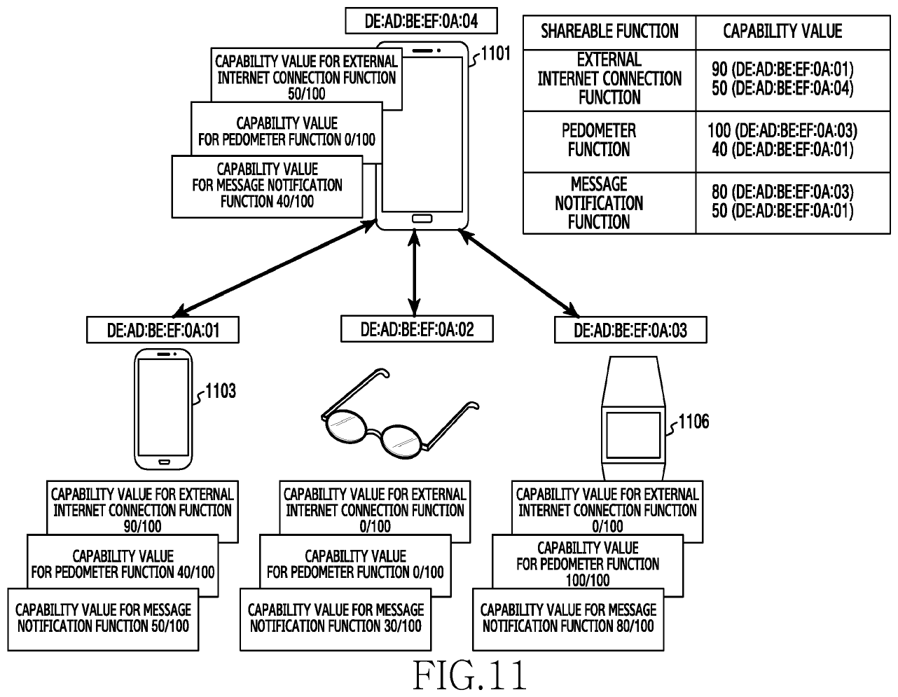

FIG. 11 is a diagram illustrating an example for determining a representative electronic device having a function that can be shared, or a shareable function, in a particular electronic device according to an embodiment of the present disclosure. In FIG. 11, it is assumed that a tablet PC 1101 is a device executing the role of an electronic device and the role of a relay device at the same time. At this time, the tablet PC 1101 may not only perform the role of a relay device, but also, when the capability value of the tablet PC 1101 for a particular function is the highest value, the tablet PC 1101 may perform or execute the particular function.

Referring to FIG. 11, the tablet PC 1101 may store therein a function-specific capability value table for an external Internet connection function, a pedometer function and a message notification function. Here, the function-specific capability value table may be generated and updated by receiving capability value information on the pedometer function and the message notification function from a plurality of electronic devices.

Firstly, the tablet PC 1101 may check, in the function-specific capability value table, that the capability value on the external Internet connection function of the electronic device (e.g. a smart phone 1103) having an ID of DE:AD:BE:EF:0A:01, corresponds to 90, and that the capability value on the external Internet connection function of the electronic device (e.g., the tablet PC 1101) having an ID of DE:AD:BE:EF:0A:04, corresponds to 50. Thereafter, the tablet PC 1101 may determine that the ID of the electronic device having the highest capability value for the external Internet connection function is DE:AD:BE:EF:0A:01, and transmit, to the electronic device (the smart phone 1103) having the corresponding ID, a signal indicating that the electronic device (the smart phone 1103) has been designated as a representative device for the external Internet connection function or receiving an external internet connection function execution command. The electronic device (the smart phone 1103) having the ID of DE:AD:BE:EF:0A: 01 may receive the external Internet connection function execution command and immediately execute the external Internet connection function, or may detect whether it is a situation requiring the external internet connection function and execute the external internet connection function.

In addition, the tablet PC 1101 may check, in the function-specific capability value table, that the capability value information on the pedometer function of the electronic device (e.g., a smartwatch 1106) having an ID of DE:AD:BE:EF:0A:03, corresponds to 100, and that the capability value information on the pedometer function of the electronic device (the smart phone 1103) having the ID of DE:AD:BE:EF:0A:01, corresponds to 40. Thereafter, the tablet PC 1101 may check that the ID of the electronic device having the highest capability value for the pedometer function is DE:AD:BE:EF:0A:03, and transmit, to the electronic device (the smartwatch 1106) having the corresponding ID, a signal indicating that the electronic device (the smartwatch 1106) has been designated as a representative electronic device for the pedometer function or receiving a pedometer function execution command. The electronic device (the smartwatch 1106) having the corresponding ID of DE:AD:BE:EF:0A:03 may receive the pedometer function execution command and immediately execute the pedometer function, or may detect whether it is a situation requiring the pedometer function execution and execute the pedometer function.

In addition, the tablet PC 1101 may check, in the function-specific capability value table, that the capability value on the message notification function of the electronic device (the smartwatch 1103) having the ID of DE:AD:BE:EF:0A:03, corresponds to 80, and that the capability value on the message notification function of the electronic device (the smart phone 1103) having the ID of DE:AD:BE:EF:0A:01, corresponds to 50. Thereafter, the relay device 1101 may check that the ID of the electronic device with the highest capability value for the message notification function is DE:AD:BE:EF:0A:03, and transmit, to the electronic device (the smartwatch 1106) having the corresponding ID, a signal indicating that the electronic device (the smartwatch 1106) has been designated as a representative electronic device for the message notification function or receiving a message notification execution command. The electronic device (the smartwatch 1106) having the ID of DE:AD:BE:EF:0A:03 may receive the message notification function execution command and immediately execute the message notification function, or may detect whether it is a situation requiring the message notification function execution and execute message notification function.

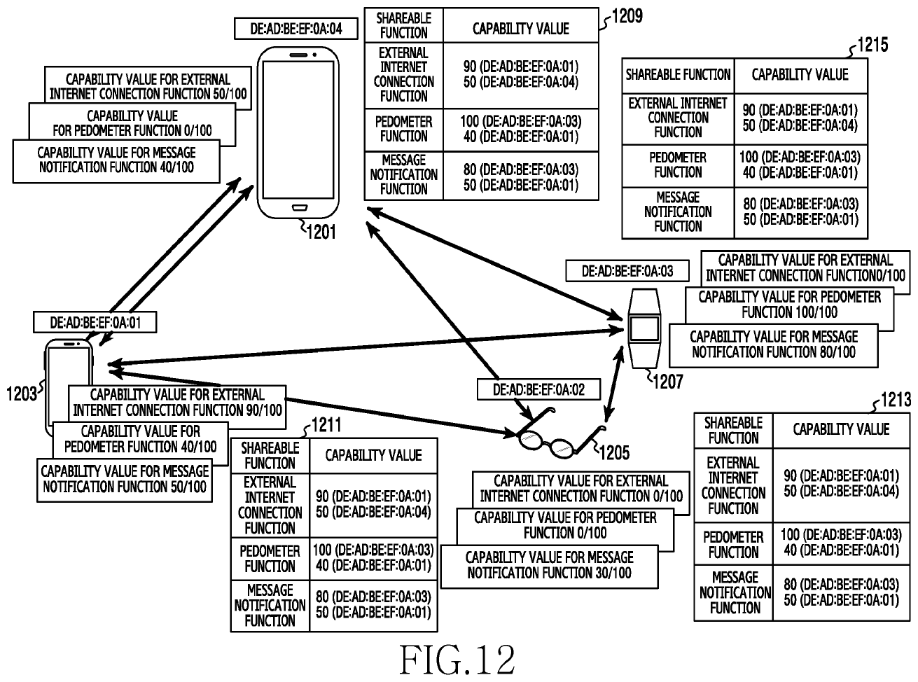

FIG. 12 is a diagram illustrating an example for determining whether to perform or execute functions that can be shared in each electronic device according to an embodiment of the present disclosure. In FIG. 12, it is assumed that there is no separate device performing the role of a relay device.

Referring to FIG. 12, each of a plurality of electric devices, such as, a tablet PC 1201 having an ID of DE:AD:BE:EF:0A:04, a smart phone 1203 having a corresponding ID of DE: AD:BE:EF:0A:01, smart glasses 1205 having a corresponding ID of DE:AD:BE:EF:0A:02, and a smartwatch 1207 having a corresponding ID of DE:AD:BE:EF:0A:03 may transmit, to other electronic devices that can share one or more shareable functions, capability values on an external Internet connection function, a pedometer function and a message notification function, and may receive, from the other electronic devices, respective capability values on the shareable functions. For example, the tablet PC 1201 may transmit, to the smart phone 1203, the smart glasses 1205, and the smartwatch 1207, which can share one or more of the functions, a capability value of 50 on the external Internet connection function, a capability value information of 0 on the pedometer function, and a capability value information of 40 on the message notification function, and may receive function-specific capability values from the smart phone 1203, the smart glasses 1205, and the smartwatch 1207. For another example, the smart phone 1203 may transmit, to the tablet PC 1201, the smart glasses 1205, and the smartwatch 1207, which can share one or more of the functions, a capability value of 90 on the external Internet connection function, a capability value of 40 on the pedometer function, and a capability value of 50 on the message notification function, and may receive function-specific capability values from the tablet PC 1201, the smart glasses 1205, and the smartwatch 1207. For yet another example, the smart glasses 1205 may transmit, to the tablet PC 1201, the smart phone 1203, and the smartwatch 1207, which can share one or more of the shareable functions, a capability value of 0 on the external Internet connection function, a capability value of 0 on the pedometer function, and a capability value 30 on the message notification function, and may receive function-specific capability values from the tablet PC 1201, the smart phone 1203, and the smartwatch 1207. For another example, the smartwatch 1207 may transmit, to the tablet PC 1201, the smart phone 1203, and the smart glasses 1205, which can share one or more of the shareable functions, a capability value of 0 on the external Internet connection function, a capability value of 100 on the pedometer function, and a capability value of 80 on the message notification function, and may receive function-specific capability values from the tablet PC 1201, the smart phone 1203, and the smart glasses 1205.

When an electronic device receives capability values different than is own capability values for each function, the electronic device may determine whether to execute respective functions or to operate as a representative device for respective functions. For example, as a result of checking a function-specific capability value table 1209, since the tablet PC 1201 may not show the highest capability value in any of the external Internet connection function, the pedometer function, and the message notification function, the tablet PC 1201 may not perform or execute any function among the functions. As another example, as a result of checking a function-specific capability value table 1211, since the smart phone 1203 shows the highest capability value for the external Internet connection function, the smart phone 1203 may perform or execute the external internet connection function. For another example, as a result of checking a function-specific capability value table 1213, since the smart glasses 1205 may not show the highest capability value in any of the external Internet connection function, the pedometer function, and the message notification function, the smart glasses 1205 may not perform or execute any function among the functions. For another example, as a result of checking a function-specific capability value table 1215, since the smartwatch 1207 shows the highest capability values for the pedometer function and the message notification function, the smartwatch 1207 may run or execute the pedometer function and the message notification function.

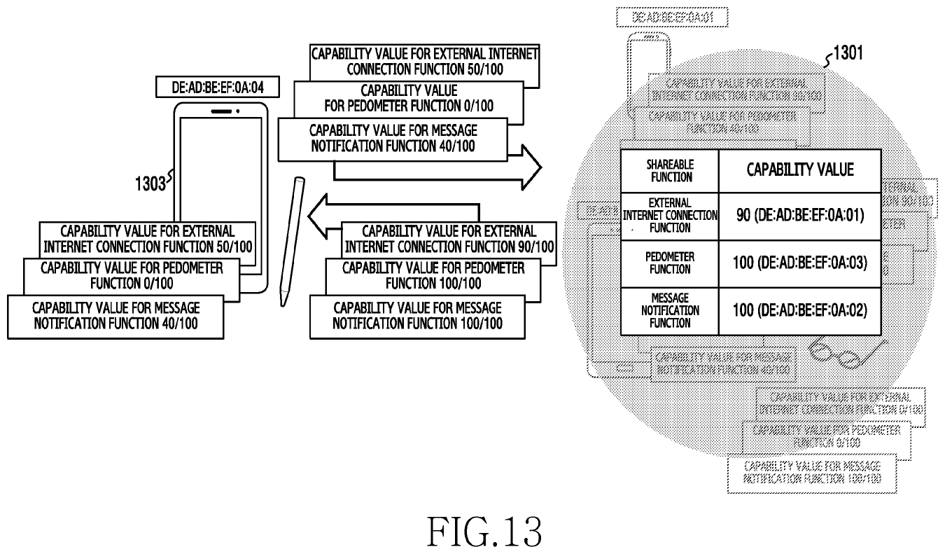

FIG. 13 is a diagram illustrating an example of a new electronic device involved in the function sharing according to an embodiment of the present disclosure. Here, the case where a new electronic device involved in the function sharing may be classified into two categories.

Firstly, if there is a relay device 1301, the new electronic device 1303 may request to participate in a group maintained by the relay device 1301, or may request a new group creation by transmitting a plurality of capability values on shareable functions to the relay device 1301.

If there is a group in which the new electronic device 1303 can participate, the relay device 1301 may add function-specific capability value information of the new electronic device 1303 to the group. On the other hand, if there is no group in which the new electronic device 1303 can participate, the relay device 1301 may create a new group and add function-specific capability value information of the new electronic device 1303 to the group. The relay device 1301 may determine whether there is a group in which the new electronic device 1303 can participate based at least on mobility, ID, and a user configuration of the new electronic device 1303. Thereafter, the relay device 1301 may transmit, to another electronic device, a function-specific capability value table to which the capability value on the new electronic device 1303 is added.

Secondly, if there is no relay device 1301, the new electronic device 1303 may transmit the capability value on the shareable functions to another electronic device which is located in the neighborhood. For example, the new electronic device 1303 may transmit the capability value on the shareable functions to other electronic devices that are detected using a peripheral device navigation function among the electronic devices included in a pre-configured list of interworking devices. For another example, the new electronic device 1303 may transmit the capability value on the shareable functions to other electronic devices that are detected using a peripheral device navigation function but are not included in the pre-configured list of interworking devices.

Thereafter, an electronic device that has received the capability value on the shareable functions of the new electronic device 1303 may add the capability value of the new electronic device 1303 to a function-specific capability value table which is stored in advance, and may determine whether to perform or execute the shareable functions based on the function-specific capability value table to which the capability value of the new electronic device 1303 is added. At this time, when the electronic device that has received the capability values on the shareable functions of the new electronic device 1303 forms a group with another electronic device, the electronic device may transmit, to another electronic device which forms the group, the function-specific capability value table to which the capability value on the new electronic devices 1303 is added.

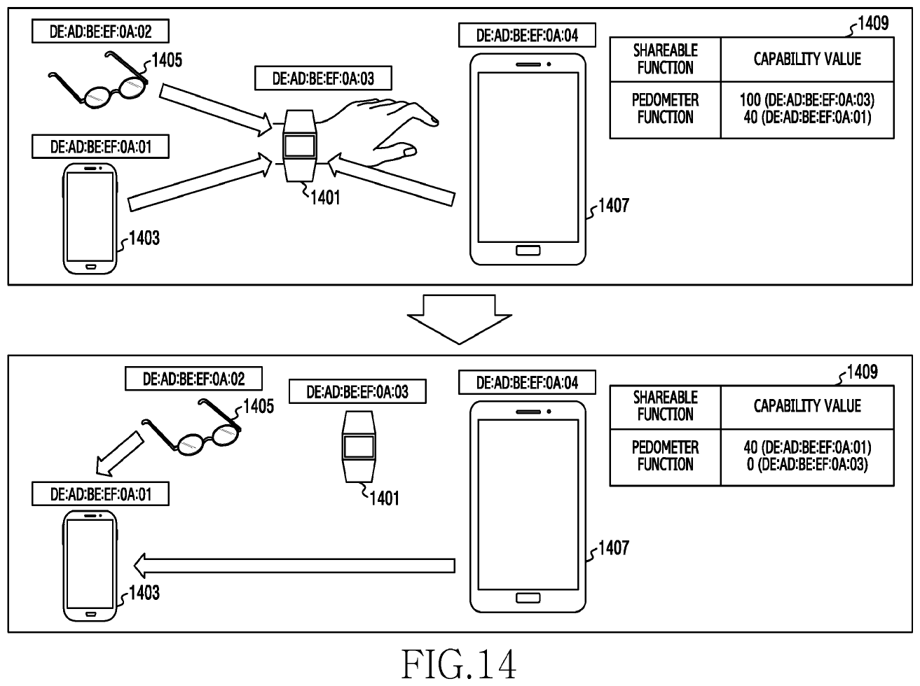

FIG. 14 is a diagram showing an example in which a representative electronic device changes depending on a change of capability values of a plurality of electronic devices according to an embodiment of the present disclosure.

Referring to FIG. 14, a situation is assumed in which the user has a group of electric devices including a smart phone 1403 having a corresponding ID of DE:AD:BE:EF:0A:01, smart glasses 1405 having a corresponding ID of DE:AD:BE:EF:0A:02, and a smartwatch 1401 having a corresponding ID of DE:AD:BE:EF:0A:03, and owns a tablet PC 1407.

Firstly, each of the electronic devices may check a function-specific capability value table 1409 for a pedometer function. As a result of checking the function-specific capability value table 1409 for the pedometer function, since the capability value on the pedometer function of smartwatch 1401 corresponds to 100 and the capability value on the pedometer function of the smart phone 1403 corresponds to 40, the smartwatch 1401 may be a representative electronic device of the pedometer function and may perform or execute the pedometer function as a representative.

Thereafter, when a detachment of the smartwatch 1401 from the group is detected, the smartwatch 1401 may update the capability value on the pedometer function from 100 to zero. Due to the function-specific capability value table for the pedometer function is being updated, each of the electronic devices may check the function-specific capability value table for the pedometer function. As a result of checking the updated function-specific capability value table, since the capability value on the smart phone 1403 corresponds to 40 and the capability value information on the pedometer functions of the smartwatch 1401 corresponds to 0, the representative electronic device of the pedometer function may be changed to the smart phone 1403 from the smartwatch 1401. At this time, for the pedometer function, since the information on a cumulative number of times that the representative electronic device is changed may be important, the smartwatch 1401, which had performed or executed the function of the representative electronic device before the change of the representative electronic device, may transmit information on the cumulative number of times of the change of the representative device of the pedometer function to the smart phone 1403, so as to continuously accumulate the cumulative number.

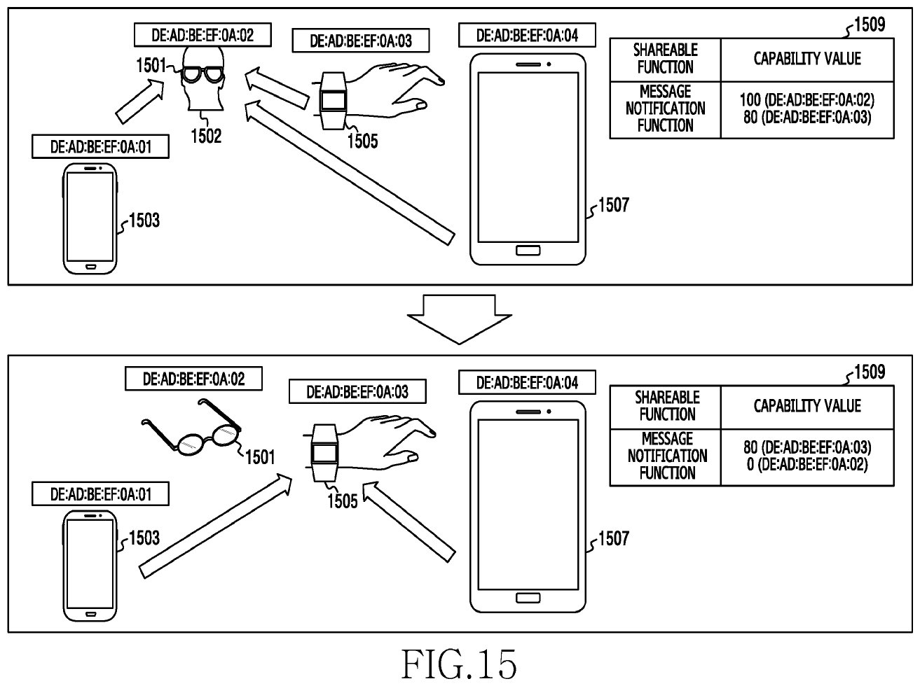

FIG. 15 is a diagram showing an example in which a representative electronic device changes depending on a change of capability values of a plurality of electronic devices according to an embodiment of the present disclosure.

Referring to FIG. 15, it is assumed that a user 1502 owns a plurality of electronic devices in a group including a smart phone 1503 having a corresponding ID of DE:AD:BE:EF: 0A:01, smart glasses 1501 having a corresponding ID of DE:AD:BE:EF:0A:02, a smartwatch 1505 having a corresponding ID of DE:AD:BE:EF:0A:03, and a tablet PC 1507 having a corresponding ID of information DE:AD:BE:EF:0A:04, and the user 1502 wears the smart glasses 1501 and the smartwatch 1505.

Firstly, each of the electronic devices may check a function-specific capability value table 1509 for a message notification function. As a result of checking the function-specific capability value table 1509 for the message notification function, since the capability value on the message notification function of the smart glasses 1501 corresponds to 100 and the capability value on the message notification function of the smartwatch 1505 corresponds to 80, the smart glasses 1501 is a representative electronic device of the message notification function and may execute or perform the message notification function.

Thereafter, when the detachment of the smart glasses 1501 is detected, the smart glasses 1501 may update the capability value on the message notification function from 100 to zero. Due to the function-specific capability value table 1509 for the message notification function being updated, each of the electronic devices may check the function-specific capability value table 1509 for the message notification function. As a result of checking the updated function-specific capability value table 1509, since the capability value on the smartwatch 1505 corresponds to 80 and the capability value on the message notification function of the smart glasses 1501 corresponds to 0, the representative electronic device of the message notification function may be changed to the smartwatch 1505 from the smart glasses 1501.

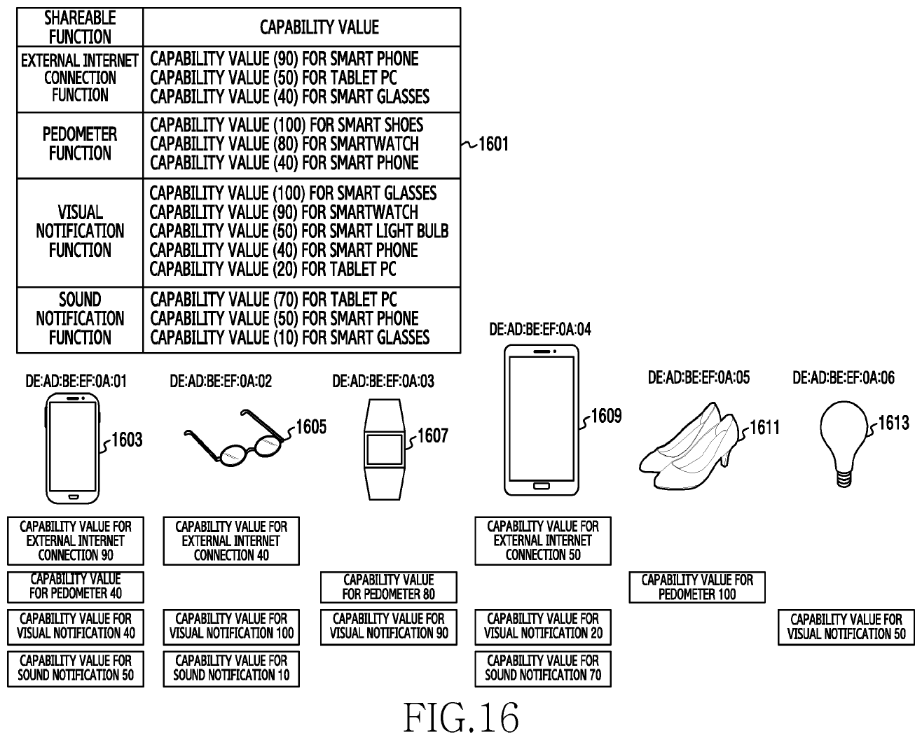

FIG. 16 is an exemplary view illustrating function-specific capability values of a plurality of electronic devices according to an embodiment of the present disclosure. FIG. 16 shows a function-specific capability value table 1601 listing a plurality of capability values on a plurality of shareable functions for a group of electronic devices. Further, each of the electronic devices also includes one or more capability values on a plurality of shareable functions.

For example, referring to FIG. 16, the capability value on an external Internet connection function of a smart phone 1603 having a corresponding ID of DE:AD:BE:EF:0A: 01 indicates 90, the capability value on a pedometer function indicates 40, the capability value on a visual notification function indicates 40, and the capability value on a sound notification function indicates 50.

In addition, the capability value on the external Internet connection function of smart glasses 1605 having corresponding ID of DE:AD:BE:EF:0A:02 indicates 40, and the capability value on the visual notification function indicates 100, and the capability value on the sound notification function indicates 10.

In addition, the capability value on the pedometer function of a smartwatch 1607 having a corresponding ID of DE:AD:BE:EF:0A:03 indicates 80, and the capability value on the visual notification function indicates 90.

In addition, the capability value information on the external Internet connection function of a tablet PC 1609 having corresponding ID of DE:AD:BE:EF:0A:04 indicates 50, and the capability value on the visual notification function indicates 20, and the capability value on the sound notification function indicates 70.

Furthermore, the capability value on the pedometer function of smart shoes 1611 having a corresponding ID of DE:AD:BE:EF:0A:05 indicates 100.

Furthermore, the capability value information on the visual notification function of a smart light bulb 1613 having a corresponding ID of DE:AD:BE:EF:0A:06 indicates 50.

The respective electronic devices according to an embodiment of the present disclosure may transmit and receive capability values on each function to and from each other, and may have the function-specific capability value table 1601 for each function, respectively. The respective electronic devices according to another embodiment of the present disclosure may transmit capability values on each function to a relay device, and the relay device may have the function-specific capability value table 1601 for each function.

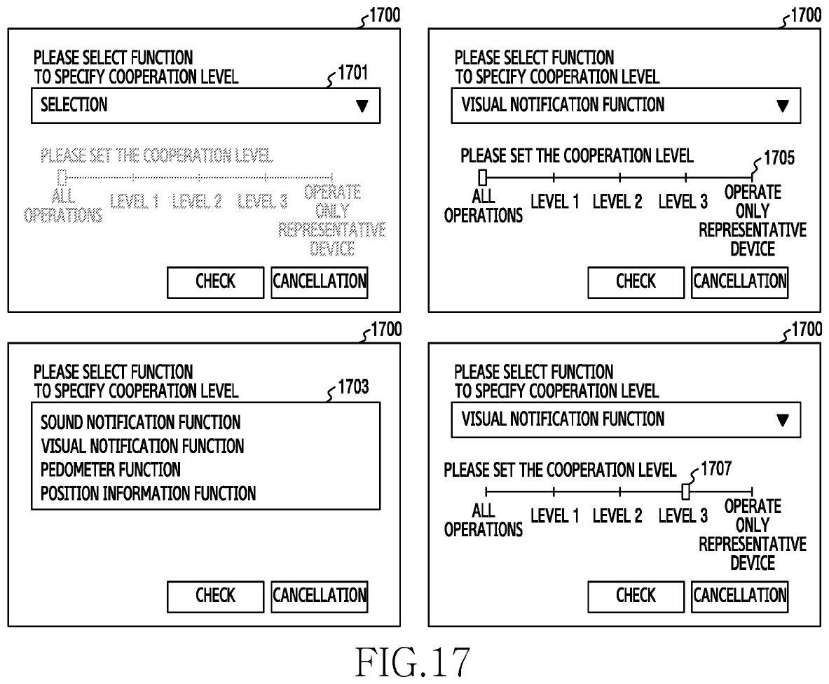

FIG. 17 is an exemplary view illustrating a user interface (UI) 1700 that determines a number of function-specific execution devices that can be interlocked in a particular electronic device according to an embodiment of the present disclosure. In FIG. 17, it is assumed that there are five electronic devices (e.g., the tablet PC 100, the smart phone 102, the smart glasses 104, and the smartwatch 106 of FIG. 1B, and the smart light bulb 1613 of FIG. 16) capable of function sharing.

Referring to FIG. 17, a user may configure a cooperation level based on the number of electronic devices to perform or execute a sharing function utilizing the illustrated UI 1700. In some embodiments, all the electronic devices or a relay device (e.g., the relay device 200 of FIG. 2) provided with a sharable function may have access to the UI 1700.

Firstly, the UI 1700 may display via a configuration process a list of shareable functions in order to configure the cooperation level of a particular shareable function. For example, when a selection menu 1701 is selected by the user, the UI 1700 may display a list 1703 including a sound notification function, visual notification function, a pedometer function and a position information function that can be shared with another electronic device.

If the user selects a particular function, the UI 1700 may display a screen to configure the cooperation level for the selected function. For example, when the visual notification function is selected, the UI 1700 may display a cooperation level configuration screen 1705 for the visual notification function.

Thereafter, when the user configures the cooperation level for the selected function, the number of electronic devices which corresponds to the selected level can be configured as representative electronic devices for the selected function. At this time, the cooperation level may be set at a level as the number of electronic devices that can be configured as representative electronic devices. For example, when the cooperation level for the visual notification function is configured to “level 3” 1707, an electronic device may configure two electronic devices that correspond to the cooperation level 3 as representative electronic devices. At this time, the electronic device may transmit information to the two electronic devices configured as representative electronic devices, and the two representative electronic devices that received the information may execute the visual notification function, as representative electronic devices for the visual notification function.

According to these embodiments, the present disclosure determines and exchanges the capability values of each of the electronic devices for each of at least one function that can be shared among a plurality of electronic devices, determines a representative electronic device for each of the at least one function based on the function-specific capability values of the electronic devices and then executes the function in the determined representative electronic device, thereby saving energy consumed in waiting for a plurality of electronic devices to perform or execute the same function and/or energy consumed for the plurality of electronic devices to repeatedly perform or execute the same function, and present disclosure allows the plurality of electronic devices to avoid executing or performing the same function to obtain an effect that the usability can be improved.

Any of the modules or programming modules according to various embodiments of the present disclosure includes at least one of the above described elements, exclude some of the elements, or further include other additional elements. The operations performed by the modules, programming module, or other elements according to various embodiments of the present disclosure can be executed in a sequential, parallel, repetitive, or heuristic manner. Further, some operations can be executed in a different order, some of the operations can be omitted, or other operations can be added.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for performing a function in a relay device, comprising:
receiving, from at least one of a plurality of electronic devices included in a group, at least one function specific capability value for at least one function when at least one factor determining the at least one function specific capability value for the at least one function is changed;
updating a function specific capability value table of the group for the at least one function based on the received at least one function specific capability value;
determining, for every predefined period, or when the function specific capability value table of the group is updated, at least one representative electronic device of the group for the at least one function based on the function specific capability value table for the group; and
transmitting at least one command message instructing an execution of the at least one function to the at least one representative electronic device of the group for the at least one function.

2. The method of claim 1, wherein, if the at least one representative electronic device of the group for the at least one function is changed, cumulative information of the at least one function is transmitted from at least one electronic device which was the at least one representative electronic device of the group for the at least one function before the change to the changed at least one representative electronic device of the group for the at least one function.

3. The method of claim 1, wherein the at least one factor determining the at least one function specific capability value of the at least one of the plurality of electronic devices comprises at least one of:
whether the at least one of the plurality of electronic devices is worn, a battery remaining amount of the at least one of the plurality of electronic devices,
a remaining operating time of the at least one of the plurality of electronic devices, an ambient noise level of the at least one of the plurality of electronic devices,
whether vibration of the at least one of the plurality of electronic devices is set, and
a frequency of use of a notification function in the at least one of the plurality of electronic devices.

4. The method of claim 1, further comprising:
forming at least one group that performs the function sharing based on mobility information of the plurality of electronic devices; and
storing, function specific capability values for the at least one function, for each of the at least one group.

5. A method for performing a function in an electronic device included in a group, the method comprising:
receiving, from at least one of a plurality of electronic devices included in the group, at least one function specific capability value for at least one function when at least one factor determining the at least one function specific capability value for the at least one function is changed;
updating a function specific capability value table of the group for the at least one function based on the received at least one function specific capability value;
determining, for every predefined period, or when the function specific capability value table of the group is updated, whether to operate the electronic device as a representative electronic device of the group for the at least one function based on the function specific capability value table for the group and function specific capability value of the electronic device.

6. The method of claim 5, wherein, if the at least one representative electronic device of the group for the at least one function is changed, cumulative information of the at least one function is transmitted from at least one electronic device which was the at least one representative electronic device of the group for the at least one function before the change to the changed at least one representative electronic device of the group for the at least one function.

7. The method of claim 5, wherein the at least one factor determining the at least one function specific capability value of the at least one of the plurality of electronic devices comprises at least one of:
whether the at least one of the plurality of electronic devices is worn,
a battery remaining amount of the at least one of the plurality of electronic devices,
a remaining operating time of the at least one of the plurality of electronic devices,
an ambient noise level of the at least one of the plurality of electronic devices,
whether vibration of the at least one of the plurality of electronic devices is set, and
a frequency of use of a notification function in the at least one of the plurality of electronic devices.

8. The method of claim 5, further comprising:
determining the function specific capability value for the at least one function executable in the electronic device; and
transmitting the determined function specific capability value information to the plurality of electronic devices included in the group.

9. The method of claim 5, wherein the determining whether to operate the electronic device for the at least one function further comprises:
determining at least one representative electronic device of the group for each of the at least one function based on the function specific capability value table for the group and the function specific capability value of the electronic device; and
transmitting at least one command message instructing an execution of the at least one function to the at least one representative electronic device of the group for the at least one function when a representative electronic device of the group for the at least one function is not the electronic device.

10. The method of claim 5, wherein the group includes at least one electronic device that is identified based on mobility information and an electronic device that is detected from a list of pre-defined interworking electronic devices using a peripheral device navigation function.

11. A relay device for performing a function, the relay device comprising:
a transceiver configured to transmit and receive signals to and from a plurality of electronic devices included in a group; and
a controller configured to:
receive, from at least one of the plurality of electronic devices, at least one function specific capability value for at least one function when at least one factor determining the at least one function specific capability value for the at least one function is changed,
update a function specific capability value table of the group for the at least one function based on the received at least one function specific capability value;
determine, for every predefined period, or when the function specific capability value table of the group is updated, at least one representative electronic device of the group for the at least one function based on the function specific capability value table for the group, and
transmit, to the at least one representative electronic device of the group for the at least one function, at least one command message instructing an execution of the at least one function via the transceiver.

12. The relay device of claim 11, wherein, if the at least one representative electronic device of the group for the at least one function is changed, cumulative information of the at least one function is transmitted from at least one electronic device which was the at least one representative electronic device of the group for the at least one function before a change to the changed at least one representative electronic device of the group for the at least one function.

13. The relay device of claim 11, wherein the at least one factor determining the at least one function specific capability value of the at least one of the plurality of electronic devices comprises at least one of:
whether the at least one of the plurality of electronic devices is worn, a battery remaining amount of the at least one of the plurality of electronic devices,
a remaining operating time of the at least one of the plurality of electronic devices, an ambient noise level of the at least one of the plurality of electronic devices,
whether vibration of the at least one of the plurality of electronic devices is set, and
a frequency of use of a notification function in the at least one of the plurality of electronic devices.

14. The relay device of claim 11, wherein the controller is further configured to form at least one group that performs the function sharing based on mobility information of the plurality of electronic devices, and to store function specific capability values for the at least function, for each of the at least one group.

15. An electronic device included in a group for performing a function, the electronic device comprising:
a transceiver configured to transmit and receive a signal to and from a plurality of electronic devices included in the group;
a controller configured to:
receive, from the at least one of a plurality of electronic devices, at least one function specific capability value for at least one function when at least one factor determining the at least one function specific capability value for the at least one function is changed,
update a function specific capability value table of the group for the at least one function based on the received at least one function specific capability value;
determine, for every predefined period, or when the function specific capability value table of the group is updated, whether to operate the electronic device as a representative electronic device of the group for the at least one function based on the function specific capability value table for the group and function specific capability value of the electronic device.

16. The electronic device of claim 15, wherein, if the at least one representative electronic device of the group for the at least one function is changed, cumulative information of the at least one function is transmitted from at least one electronic device which was the at least one representative electronic device of the group for the at least one function before a change to the changed at least one representative electronic device of the group for the at least one function.

17. The electronic device of claim 15, wherein the at least one factor determining the at least one function specific capability value of the at least one of the plurality of electronic devices comprises at least one of:
whether the at least one of the plurality of electronic devices is worn,
a battery remaining amount of the at least one of the plurality of electronic devices,
a remaining operating time of the at least one of the plurality of electronic devices,
an ambient noise level of the at least one of the plurality of electronic devices,
whether vibration of the at least one of the plurality of electronic devices is set, and
a frequency of use of a notification function in the at least one of the plurality of electronic devices.

18. The electronic device of claim 15, wherein the controller is further configured to determine the function specific capability value for the at least one function executable in the electronic device, and to transmit the determined function specific capability value information to the plurality of electronic devices included in the group via the transceiver.

19. The electronic device of claim 15, wherein the controller is further configured to determine at least one representative electronic device of the group for each of the at least one function based on the function specific capability value table for the group and the function specific capability value of the electronic device, and to transmit, to the at least one representative electronic device of the group for the at least one function, at least one command message instructing an execution of the at least one function via the transceiver, when a representative electronic device of the group for the at least function is not the electronic device.

20. The electronic device of claim 15, wherein the group includes at least one electronic device that is identified based on mobility information and an electronic device that is detected from a list of pre-defined interworking electronic devices using a peripheral device navigation function
